(19) United States
(12) Patent Application Publication
(10) Pub. No.: US 2016/0124394 A1
(43) Pub. Date: May 5, 2016

(54) WIRELESS INDUCTIVE POINTER CLOCK

(71) Applicant: Hua Wen Hsu, Taipei City (TW)

(72) Inventor: Hua Wen Hsu, Taipei City (TW)

(21) Appl. No.: 14/528,129

(22) Filed: Oct. 30, 2014

(51) Int. Cl. G04G 9/00; G04G 11/00

(52) U.S. Cl. CPC G04G 9/0005; G04G 9/0064; G04G 11/00

(57) ABSTRACT

A wireless inductive display clock includes a wireless inductive receiver module, a control circuit module, and a display unit. The wireless inductive receiver module can be, for example, an NFC module. The control circuit module is electrically connected to the wireless inductive receiver module for receiving an information signal from the wireless inductive receiver module and converting it into an information display signal, for example, time display signal. The display unit is, for example, a LCD electrically connected to the control circuit module for receiving the information display signal and drivable by the control circuit module to display the information. Thus, the wireless inductive receiver module can receive a wireless information signal from a mobile phone or other electronic information device so that the control circuit module can process the information signal and then drive the display unit to display the time and/or other information, enabling the time on wireless inductive display clock to be synchronized to the time on the electronic information device.

### BACKGROUND OF THE INVENTION

1. Field of the Invention

The present invention relates to clock technology and more particularly, to a wireless inductive display clock, which can be automatically synchronized to the time or other information on a smart phone or tablet computer upon approaching of the smart phone or tablet computer.

2. Description of the Related Art

Commercial clocks, either pointer Clocks or LCD clocks, commonly have different appearance designs or dial patterns to attract consumers. However, correction of the position of the hour hand, minute hand or second hand of a conventional display clock can simply be achieved manually. When wishing to correct the time on a large clock that is hung on a wall, the user needs to remove the clock from the wall for correction. After correction, the user needs to hang the display clock on the wall again. It is very inconvenient to adjust the indication of time on a conventional clock.

Further, most of the people have a mobile phone that provides time displaying and alarm functions. However, when a mobile phone is not in use, the screen will be automatically turned off, and thus the display of time on the screen cannot be seen 24 hours a day like the display of time on a clock when the screen is off. When going to see the display of time on the screen of the mobile phone, the user needs to turn on the screen of the mobile phone.

Further, a conventional LCD clock can simply display time without providing the function of displaying information of weather, temperature and tides. This monotonous design cannot attract people. Therefore, there is a strong demand for a display clock capable of display the information of time, weather, temperature, tides, and other life information in graphics or text.

### SUMMARY OF THE INVENTION

The present invention has been accomplished under the circumstances in view. It is therefore the main object of the present invention to provide a wireless inductive display clock, which uses a wireless inductive receiver module to receive the time code or other information on an electronic information device in a wireless manner, enabling the time or other information on the wireless inductive display clock to be automatically synchronized to the time or other information on the electronic information device.

To achieve this and other objects of the present invention, a wireless inductive display clock of the invention comprises a wireless inductive receiver module, a control circuit module, and a display unit. The wireless inductive receiver module is adapted to receive an information signal in a wireless manner. The control circuit module is electrically coupled to the wireless inductive receiver module for receiving the information signal (such as time, calendar, weather, alarm, temperature, tides, etc.) from the wireless inductive receiver module. The control circuit module comprises a time processing circuit for processing a time code of the information signal into a time display signal. The display unit is electrically connected to the control circuit module. The display unit comprises a time display zone for receiving the time display signal from the control circuit module and drivable by the time display signal to display time.

In application, the wireless inductive receiver module receives an information signal (time, calendar, weather, tides, alarm, temperature or other information) from a mobile phone, computer or other electronic information device is a wireless manner, enabling the information signal to be processed by the control circuit module and converted into a display signal for driving a time display zone, alarm display zone, temperature display zone or weather display zone of the display unit to display the time, alarm, temperature, weather in graphics, text or symbols. Thus, the time on the wireless inductive display clock can be automatically synchronized to the time on the electronic information device in a wireless manner.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic front view of a wireless inductive display clock in accordance with the present invention.

FIG. 2 is a schematic rear view of the wireless inductive display clock in accordance with the present invention.

FIG. 3 is a schematic top view of the wireless inductive display clock in accordance with the present invention.

FIG. 4 is a system block illustrating the wireless inductive display clock in operation with an electronic information device in accordance with the present invention.

FIG. 5 is a circuit diagram of the wireless inductive display clock in accordance with the present invention.

FIG. 6 illustrates an alternate form of the display unit in accordance with the present invention.

### DETAILED DESCRIPTION OF THE PREFERRED EMBODIMENT

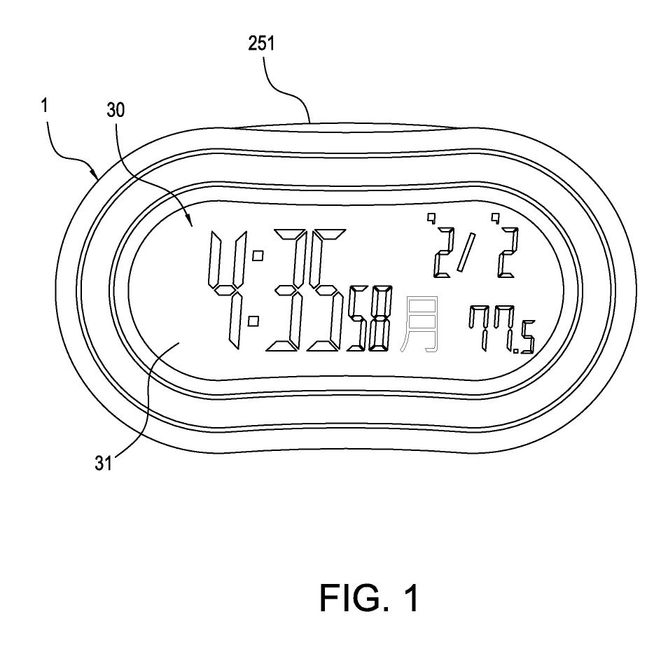

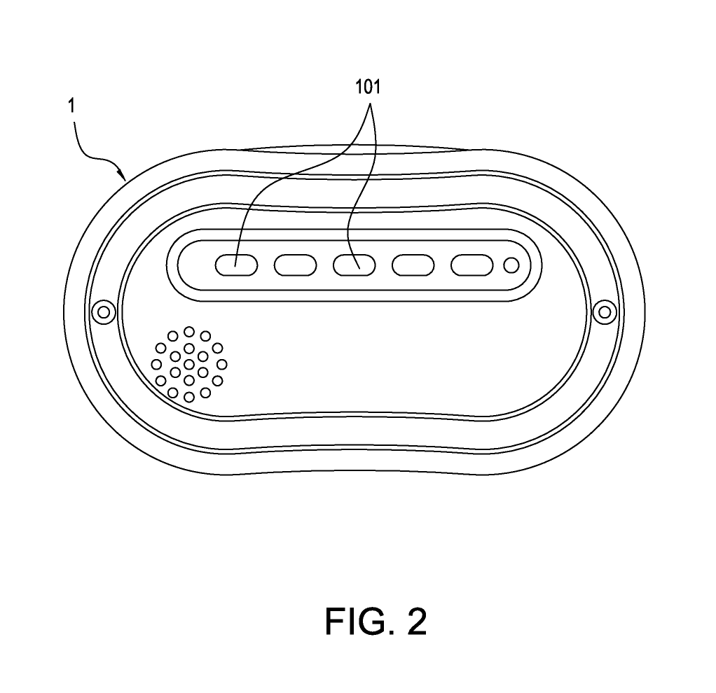

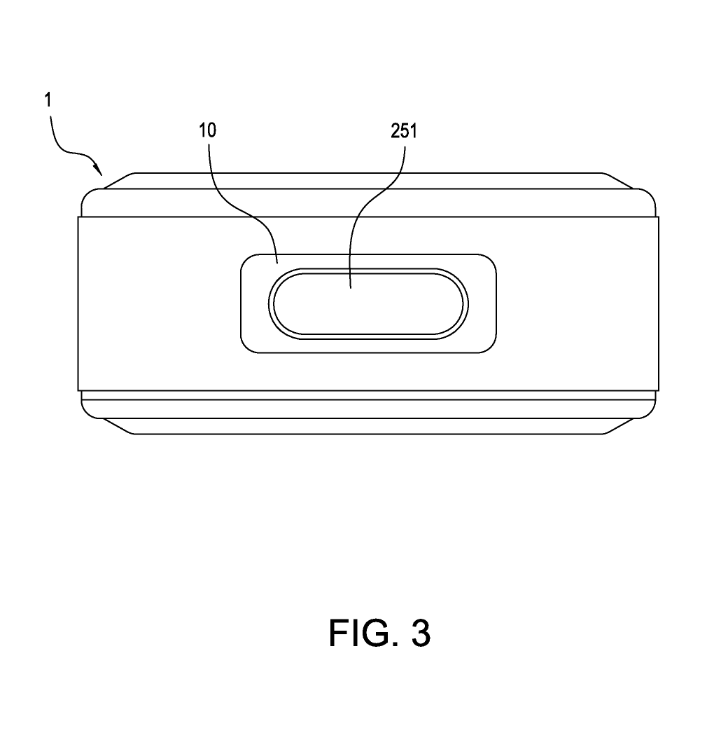

Referring to FIGS. 1-5, a wireless inductive display clock 1 in accordance with the present invention is shown. The wireless inductive display clock 1 comprises a wireless inductive receiver module 10 adapted for wirelessly receiving an information signal containing a time code or other data, a control circuit module 20 comprising a time processing circuit 21 and electrically connected with the wireless inductive receiver module 10 and adapted for receiving and processing the information signal from the wireless inductive receiver module 10 and converting the time code into a time display signal, and a display unit 30 comprising a time display zone 31 and electrically connected with the control circuit module 20 and adapted for receiving the time display signal from the control circuit module 20 and driving by the time display signal to display time.

Referring to FIGS. 1, 4 and 5 again, an electronic information device 40 is used for allowing the user to control the settings of the wireless inductive display clock 1. The electronic information device 40 can be a smart phone, tablet computer, or any of a variety of other mobile electronic devices.

The electronic information device 40 comprises an information module 41, and a wireless inductive transmitter module 42. The information module 41 can be a smart phone application software or computer application software for providing a variety of information such as time, weather, alarm, temperature, tides, etc. that can be received, stored or outputted in a signal form of number, symbol, graphic, or color. In this embodiment, the information signal is a time code. The information (such as hours, minutes, seconds, day, year, month, sun and moon calendar, etc,) stored in the electronic information device 50 can be automatically synchronized to the wireless inductive display clock 1. The wireless inductive transmitter module 42 is electrically connected to the information module 41 for outputting the time code of the information module 41. The wireless inductive transmitter module 42 mates with wireless inductive receiver module 10 of the wireless inductive display clock 1 for the transmission of the time code.

In application, the desired information can be wirelessly transmitted by the electronic information device 40 to the wireless inductive display clock 1, enabling the wireless inductive receiver module 10 to receive the information (such as hours, minutes, seconds, day, year, month, sun and moon calendar, etc,) from the electronic information device 40. Thereafter, the control circuit module 20 processes the information signal and then drives the time display zone 31 of the display unit 30 to display time, and thus, the time on the wireless inductive display clock 1 is automatically synchronized to the time on the electronic information device 40, enabling the user to see the display of time 24 hours a day. When seeing the display of time on the wireless inductive display clock 1, the user needs not to turn on the electronic information device 40 (smart phone, computer, or TV). Thus, the user can conveniently synchronize the time on the wireless inductive display clock 1 to the time on the electronic information device 40 conveniently without moving the wireless inductive display clock 1 from the wall.

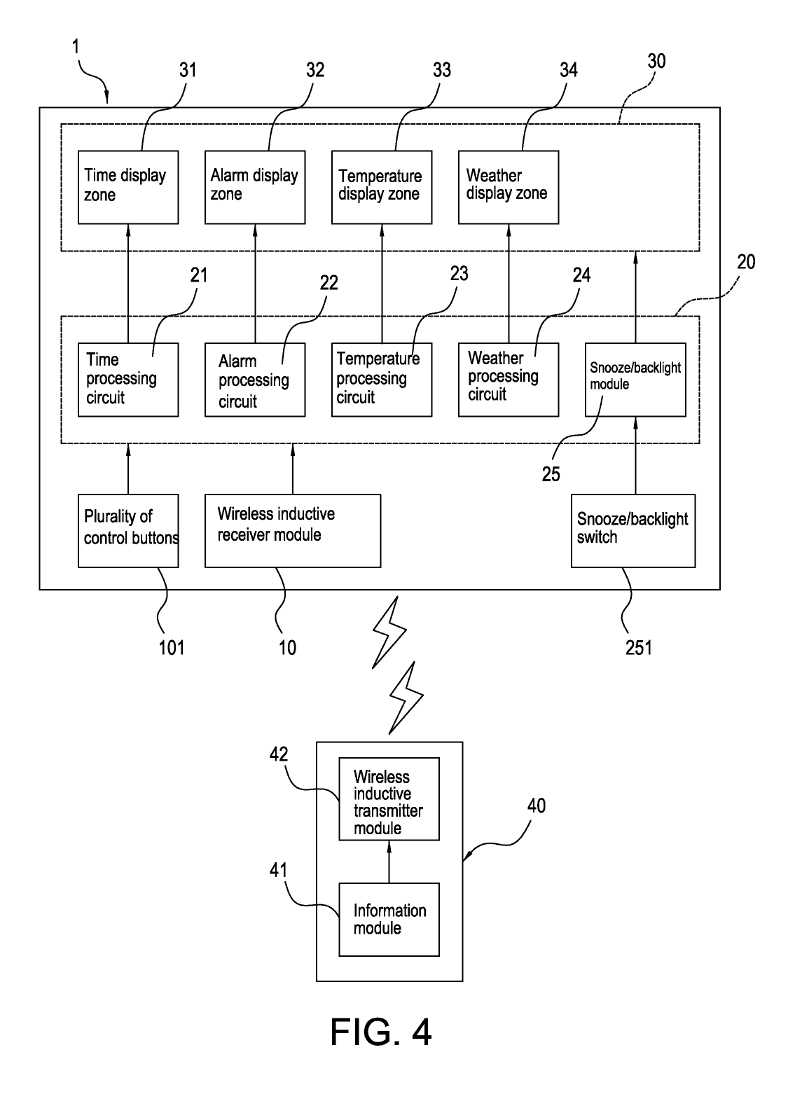

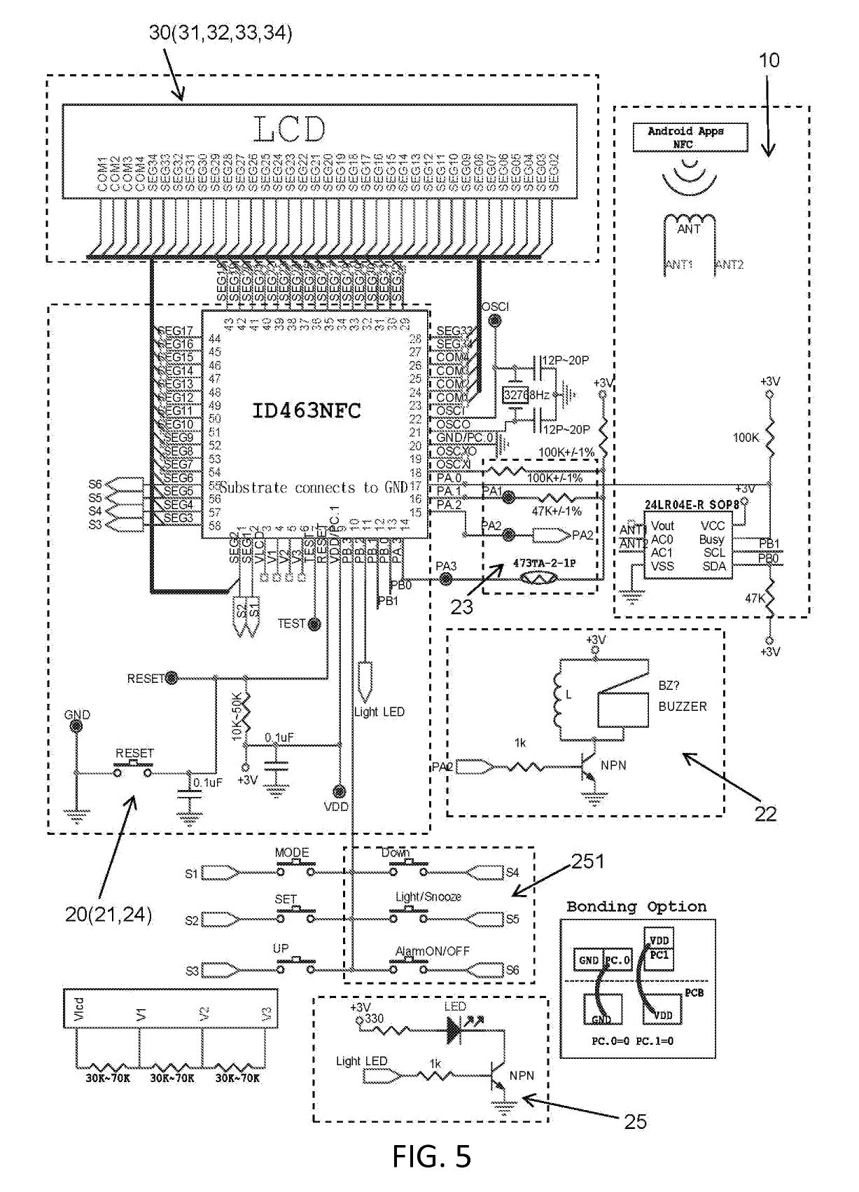

Referring to FIGS. 4 and 5 again, the wireless inductive receiver module 10 can be configured subject to NFC (Near Field Communication), Bluetooth, WiFi, or ZigBee specifications. In the present preferred embodiment, the wireless inductive receiver module 10 is an NFC module. However, this configuration is not a limitation. In other embodiments of the present invention, the wireless inductive receiver module 10 can be configured subject to Bluetooth, WiFi or ZigBee specifications.

Referring to FIGS. 1, 4 and 5 again, in the present preferred embodiment, the display unit 30 is a LCD (Liquid Crystal Display).

Referring to FIG. 6 and FIGS. 4 and 5 again, in one embodiment of the present invention, the wireless inductive receiver module 10 is adapted to receive a wireless alarm information signal from the electronic information device 40; the control circuit module 20 comprises an alarm processing circuit 22 adapted to convert the alarm information signal into an alarm display signal; the display unit 30 comprises an alarm display zone 32 for receiving the alarm display signal from the control circuit module 20 and displaying the time of the alarm display signal.

In another embodiment of the present invention, the wireless inductive receiver module 10 is adapted to receive a temperature information signal from the electronic information device 40; the control circuit module 20 comprises a temperature processing circuit 23 adapted to convert the temperature information signal into a temperature display signal; the display unit 30 comprises a temperature display zone 33 for receiving the temperature display signal from the control circuit module 20 and displaying the temperature. Using the same technology, the wireless inductive receiver module 10 can be configured to receive a humidity information signal from the electronic information device 40; the control circuit module 20 can be configured to convert the humidity information signal into a humidity display signal; the display unit 30 can be configured to provide a humidity display zone for receiving the humidity display signal from the control circuit module 20 and displaying the humidity.

In still another embodiment of the present invention, the wireless inductive receiver module 10 is adapted to receive a weather information signal from the electronic information device 40; the control circuit module 20 comprises a weather processing circuit 24 for converting the weather information signal into a weather display signal; the display unit 30 comprises a weather display zone 34 for receiving the weather display signal from the control circuit module 20 and display the weather. Further, the weather display signal can be one of the weather graphics of sunny, rain, thunderstorms, and cloudy

Referring to FIGS. 1-5 again, the control circuit module 20 further comprises a snooze/backlight module 25 electrically connected to the display unit 30, and a snooze/backlight switch 251 electrically connected to the snooze/backlight 25. When the alarm alarms, the user can press the snooze/backlight switch 251 to temporarily stop the alarm and to simultaneously initiate the snooze/backlight module 25, causing the display unit 30 to produce a backlight for a predetermined length of time (several seconds), and allowing the alarm to be started again after a predetermined time interval (for example, 5 minutes).

The wireless inductive display clock 1 further comprises a plurality of control buttons 101 electrically connected to the control circuit module 20 and operable to switch on/off the power supply of the wireless inductive display clock 1 and to control the setting of the various functions of the wireless inductive display clock 1.

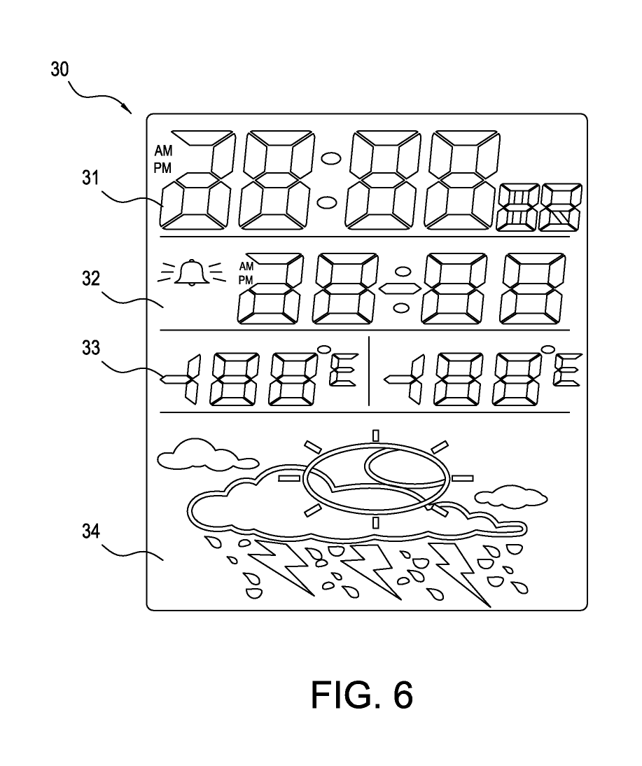

Further, the various display zones (time display zone 31, alarm display zone 32, temperature display zone 33, weather display zone 34, etc.) of the display unit 30 can be arranged together (see FIG. 6). Alternatively, the various display zones (time display zone 31, alarm display zone 32, temperature display zone 33, weather display zone 34, etc.) of the display unit 30 can be disposed at different locations of the housing of the wireless inductive display clock 1.

Thus, the wireless inductive display clock of the invention has the features and advantages as follows:
1. When kept in proximity to the wireless inductive transmitter module, such as the NFC antenna induction zone, of the smart phone or tablet computer, the time on the wireless inductive display clock is automatically synchronized to the time on the smart phone or tablet computer, and thus the time indication of the wireless inductive display clock can be automatically corrected without removing the wireless inductive display clock from the wall.
2. The setting of the alarm time and other functions of the wireless inductive display clock can be completed conveniently and rapidly by a smart phone.
3. The user can wirelessly download the latest weather information onto the wireless inductive display clock, and thus, the user can see the accurate weather display on the wireless inductive display clock without opening the smart phone.
4. The wireless inductive display clock can display the calendar in hour, minute, second, week, year, moth, day.

In conclusion, the wireless inductive display clock of the invention uses the wireless inductive receiver module to receive a n information signal from an electronic information device in a wireless manner, and the control circuit module to control the display unit to display, time, alarm, temperature and/or weather. Further, the time on the wireless inductive display clock can be automatically synchronized to the time on the electronic information device in a wireless manner.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A wireless inductive display clock, comprising:
a wireless inductive receiver module adapted for receiving an information signal containing a time code in a wireless manner;
a control circuit module electrically coupled to said wireless inductive receiver module and adapted for receiving said information signal from said wireless inductive receiver module and converting said time code of said information signal into a time display signal; and
a display unit electrically coupled to said control circuit module, said display unit comprising a time display zone adapted for receiving said time display signal from said control circuit module and drivable by said time display signal to display time.

2. The wireless inductive display clock as claimed in claim 1, further comprising an electronic information device adapted for providing said information signal to said wireless inductive receiver module wirelessly.

3. The wireless inductive display clock as claimed in claim 2, wherein said electronic information device comprises an information module and a wireless inductive transmitter module, said information module comprising an information stored in said electronic information device, said wireless inductive transmitter module being electrically coupled to said information module and adapted for outputting said information of said information module.

4. The wireless inductive display clock as claimed in claim 3, wherein said information module is a mobile phone/computer application software for modularizing said information into said information signal.

5. The wireless inductive display clock as claimed in claim 1, wherein said display unit is a LCD.

6. The wireless inductive display clock as claimed in claim 1, wherein said wireless inductive receiver module is configured subject to NFC (Near Field Communication), Bluetooth, WiFi, or ZigBee specifications.

7. The wireless inductive display clock as claimed in claim 2, wherein said wireless inductive receiver module is also adapted for receiving an alarm information signal of said information signal provided by said electronic information device; said control circuit module further comprises an alarm processing circuit adapted for converting said alarm information signal into an alarm display signal;
said display unit further comprises an alarm display zone adapted for receiving said alarm display signal from said control circuit module and drivable by said alarm display signal to display alarm time.

8. The wireless inductive display clock as claimed in claim 7, wherein said control circuit module further comprises a snooze/backlight module, and a snooze/backlight switch electrically coupled with said snooze/backlight and said display unit and pressable to initiate a snooze function and to drive said display unit to generate a backlight when said alarm display signal alarms.

9. The wireless inductive display clock as claimed in claim 2, wherein said wireless inductive receiver module is also adapted for receiving a temperature information signal of said information signal provided by said electronic information device; said control circuit module further comprises a temperature processing circuit adapted for converting said temperature information signal into a temperature display signal; said display unit further comprises a temperature display zone adapted for receiving said temperature display signal from said control circuit module and drivable by said temperature display signal to display temperature and humidity.

10. The wireless inductive display clock as claimed in claim 2, wherein said wireless inductive receiver module is also adapted for receiving a weather information signal of said information signal; said control circuit module further comprises a weather processing circuit for converting said weather information signal into a weather display signal; said display unit further comprises a weather display zone adapted for receiving said weather display signal from said control circuit module and drivable by said weather display signal to display weather.
